(19) United States
(12) Patent Application Publication
(10) Pub. No.: US 2003/0216098 A1
(43) Pub. Date: Nov. 20, 2003

(54) Dissolvable polyvinyl alcohol nonwoven

(76) Inventors: Thomas Carlyle, Huntersville, NC (US); Miguel Rivera, Mooresville, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/370,240

(22) Filed: Feb. 19, 2003

Related U.S. Application Data
(60) Provisional application No. 60/357,492, filed on Feb. 19, 2002.

(51) Int. Cl. B32B 17/00

(52) U.S. Cl. 442/400; 156/62.4

(57) ABSTRACT

The present invention relates to a method of preparing a melt-extruded fabric, such as a melt-blown nonwoven fabric capable of dissolution, and more specifically, the present invention relates to a melt-blown nonwoven fabric comprising a polyvinyl alcohol resin capable of totally dissolving in water temperatures up to about 72° Fahrenheit with some mild agitation, such as shaking or stirring.

### TECHNICAL BACKGROUND

The present invention relates to a method of preparing a melt-extruded nonwoven fabric, such as a melt-blown fabric, which is capable of dissolution, and more specifically, the present invention relates to a melt-extruded nonwoven fabric embodying a polyvinyl alcohol resin capable of totally dissolving in cold water.

### BACKGROUND OF THE INVENTION

Disposable absorbent articles, such as feminine care products, diapers, and the like, along with medical manufactured goods, such as gowns, surgical drapes, and face masks, produce a large amount of waste every year. Due to the increase in consumption of such disposable products, it has become necessary to replace traditional substrates with those that are capable of expedient environmental degradation by nature. The introduction of polyvinyl alcohol to a substrate is one such way to produce a dissolvable product.

The utilization of polyvinyl alcohol in textile, including woven, knit, and nonwoven fabrics, is well known in the art. The production of conventional textile fabrics or wovens, is known to be a complex, multi-step process. Woven fabrics are those fabrics comprised of a plurality of warp and weft yarns that are interlaced on a loom, where as the production of nonwoven fabrics is known to be more efficient than traditional textile processes.

Nonwoven fabrics are comprised of fibers or filaments or a combination thereof, which are formed into a web or batt and then bonded or interlocked by means commonly known to one skilled in the art.

Polyvinyl alcohol (PVOH) has been employed in fibers, adhesives, binding agents, and dispersing agents for emulsions. U.S. Pat. No. 4,343,403 to Daniels, et al, is representative of the art, whereby PVOH is incorporated into an emulsion that is either coated or impregnated into a nonwoven wipe rendering the disclosed wipe dispersible in cold water. This process requires the emulsification of the PVOH into a suitable carrier medium, and the subsequent application of that emulsion into the nonwoven by suitable application means. This process requires extra time for the creation and application of the emulsion, as well as requiring additional drying time so that the emulsion may be allowed to dry.

U.S. Pat. No. 5,620,786 to Honeycutt, et al., discloses a method of producing medical supplies, such as gauze, sponges, and towels, which are soluble in hot water due to utilization of a PVOH doped-resin that is then extruded. Dope extrusion is a time consuming process whereby the resin is dissolved into de-ionized or distilled water and then allowed to incubate for significant periods until the solution undergoes a gel formation.

An unmet need exists involving the utilization of PVOH in an expedient and direct fabric formation process. The use of PVOH resin in a melt-blown substrate is advantageous since there is a complete dissolution of the substrate, as opposed to other substrates that are merely coated with PVOH and leave behind fibrous debris. The present invention also addresses the need to efficiently produce a cold water soluble nonwoven fabric employing a PVOH resin, wherein cold water refers to water temperatures up to about 70° Fahrenheit, that is, up to about room temperature. The disclosed invention describes the use of a PVOH resin as a melt-blown nonwoven suitable for end use applications in hygiene and/or medical products.

### SUMMARY OF THE INVENTION

The present invention relates to a method of preparing a melt-extruded fabric, such as a melt-blown nonwoven fabric capable of dissolution, and more specifically, the present invention relates to a melt-blown nonwoven fabric comprising a polyvinyl alcohol resin capable of totally dissolving in water temperatures up to about 72° Fahrenheit with some mild agitation, such as shaking or stirring.

Polyvinyl alcohol (PVOH) is traditionally manufactured by polymerizing vinyl acetate and hydrolyzing the polymer to an alcohol. Polyvinyl alcohols vary in their degree of polymerization and their degree of hydrolysis. PVOH can be manufactured as either a water-soluble or water insoluble resin. The temperature at which polyvinyl alcohol dissolves can vary by means of altering polymer orientation, by changing its degree of hydrolysis, and crystallization. The PVOH of the present invention is no more than 95% hydrolyzed.

It is the objective of the present invention to efficiently produce a melt-extruded fabric utilizing a PVOH resin that is completely dissolvable in water temperatures up to about 72° Fahrenheit along with some mild agitation, which may be applied in disposable and/or absorbent articles. The utilization of PVOH in a more direct manner than has been previously used in the prior art, such as in a resin, instead of a PVOH topical treatment, will reduce the amount of process time required to render a melt-extruded fabric completely dissolvable in water temperatures equal to or greater than 34° Fahrenheit.

A further embodiment is the formation of multilayer laminate or composite constructs wherein one or more layers comprise a melt-extruded nonwoven component comprised of PVOH resin. Such constructs exhibit the ability to facilitate dispersability in end-use articles which necessarily include materials which do not exhibit inherent deconstruction when exposed to water temperatures up to about 72° Fahrenheit.

A particularly preferred embodiment includes the formation of a melt-extruded dissolvable nonwoven construct referred to as a spunbond/melt-blown/spunbond or SMS. This three-layered fabric construct comprises two exterior layers of a dissolvable spunbond and an interior PVOH melt-blown layer of the present invention.

### BRIEF DESCRIPTION OF THE DRAWINGS

FIG. 1 is a schematic view of the apparatus utilized to carry out the melt-blown process.

FIG. 2 shows a perspective view of surgical gown used in an embodiment of the present invention.

### DETAILED DESCRIPTION OF THE INVENTION

While the present invention is susceptible of embodiment in various forms, hereinafter is described a presently preferred embodiment of the invention, with the understanding that the present disclosure is to be considered as an exemplification of the invention, and is not intended to limit the invention to the specific embodiment illustrated.

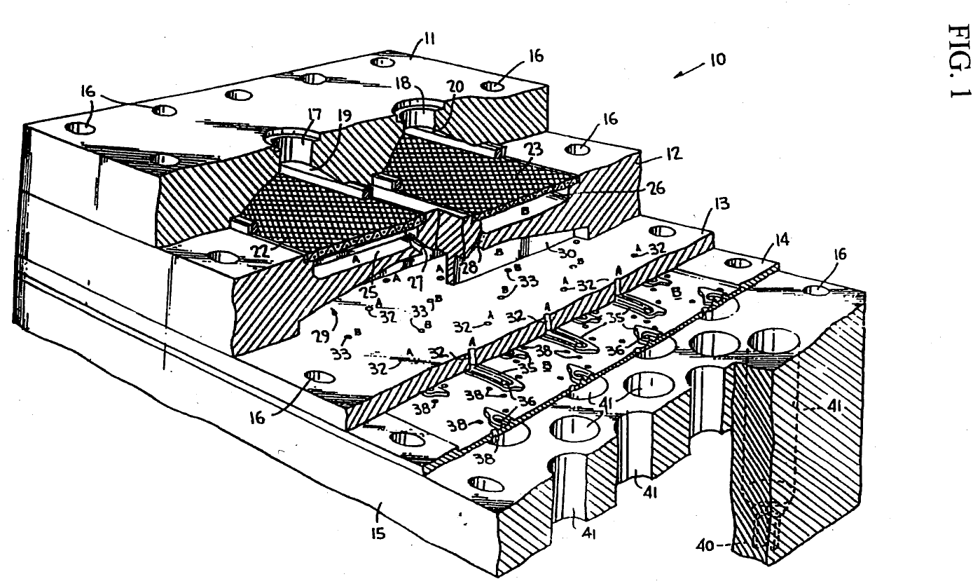

In reference to FIG. 1, the nonwoven fabric 1 of the present invention is a melt-extruded nonwoven, as exemplified by melt-blown fabrics or spunbond fabrics, and any combinations thereof. The melt-extruded fabric of the present invention may also be one or more layers of a laminate or composite construct that may include other wovens, knits, nonwovens, foams, films, and coforms.

A melt-blown nonwoven fabric is obtained in much the same manner as a spunbond nonwoven fabric, which are collectively referred to as melt-extruded, or meltspun. A spunmelt process utilizes a molten polymer whereby the molten polymer is extruded under pressure through orifices in a spinneret or die. High velocity air impinges upon and entrains the filaments as they exit the die in the melt-blown process. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll.

The present invention is meant to include melt-extruded fabrics comprising nano-denier filaments as well. Suitable nano-denier continuous filament barrier layers can be formed by either direct spinning of nano-denier filaments or by formation of a multi-component filament that is divided into sub-denier filaments prior to deposition on a substrate layer. U.S. Pat. No. 5,679,379 and U.S. Pat. No. 6,114,017, incorporated herein by reference, exemplify direct spinning processes practicable in support of the present invention. Multi-component filament spinning with integrated division into sub-denier filaments can be practiced in accordance with the teachings of U.S. Pat. No. 5,225,018, and U.S. Pat. No. 5,783,503, incorporated herein by reference.

The dissolvable melt-blown fabric embodying the principles of the present invention is comprised of a PVOH resin, known commercially as C.72T/FG, which is commercially available through PVAXX, located in Fort Myers, Fla. The PVOH resin is at least 20% hydrolyzed and no more than 95% hydrolyzed, making the melt-blown fabric totally soluble in water temperatures up to about 72° Fahrenheit along with mild agitation. The dissolvable melt-blown fabric has of basis weight range of about 0.75 to 8.15 ounces per square yard, with a more preferred basis weight range with about 1.0 to 7.0 ounces per square yard, and a most preferred basis weight range of about 1.5 to 5.0 ounces per square yard. The melt-blown fabric is comprised of fibers with a denier range of about 1 to 15 microns, with a preferred range of about 1 to 8 microns, and a most preferred range of 1 to 2 microns.

It is within the purview of the present invention that the dissolvable melt-blown fabric can be treated with aesthetic or performance-modifying additives, such as represented by pigments, surfactants, and photostabilizers by use of a topical application means and/or by introduction of the additive into the PVOH resin. The dissolvable melt-blown fabric may also be a layer within a multi-layered construct whereby the composite or laminate fabric is then at least temporarily consolidated, usually by means involving heat and pressure, such as by thermal point bonding. The disclosed fabric has various end uses, such as in medical and hygiene applications. Suitable medical end-use applications include, but are not limited to surgical gowns, face masks, surgical drapes, and surgical utensil tray liners. Suitable hygiene end-use applications include absorbent article components such as incontinence briefs, incontinence undergarments, diaper holders and liners, feminine hygiene garments, training pants, pull-on garments, and the like.

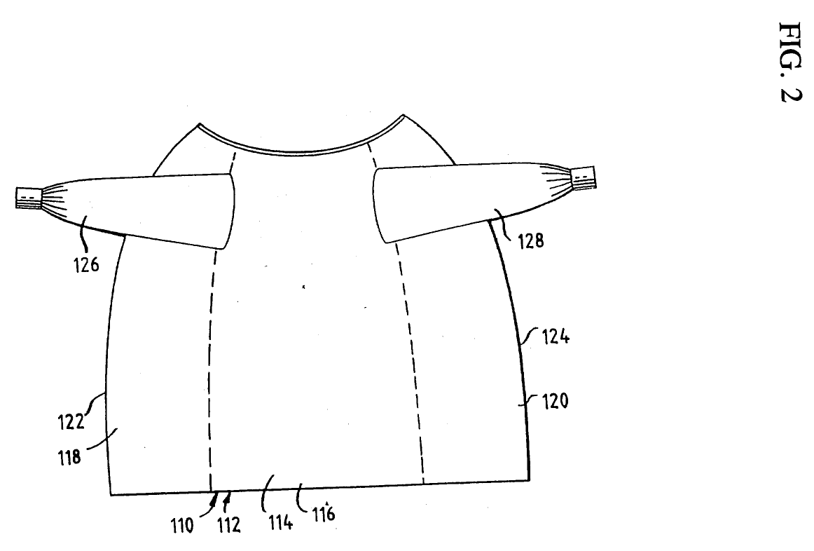

Referring now to FIG. 2, there is shown a disposable garment generally designated 110 comprising a surgical gown 112. The gown 112 comprises a body portion 114, which may be one-piece, having a front panel 116 for covering the front of the wearer, and a pair of back panels 118 and 120 extending from opposed sides of the front panel 116 for covering the back of the wearer. The back panels 118 and 120 have a pair of side edges 122 and 124, respectively, which define an opening on the back of the gown. The gown 112 has a pair of sleeves 126 and 128 secured to the body portion 114 of the gown for the arms of the wearer. In use, the back panels 118 and 120 overlap on the back of the wearer in order to close the back opening of the gown, and suitable belt means (not shown) is utilized to secure the back panels 118 and 120 in the overlapping relationship.

Further, the disclosed dissolvable melt-extruded nonwoven fabric is suitable for components of diapers or catamenial products, such as feminine hygiene pads, whereby a topsheet and a backsheet are affixed about a central absorbent core. The overall design of the catamenial product is altered to best conform to the human shape and for absorbing human exudates. Representative prior art to such article fabrication include U.S. Pat. No. 4,029,101, U.S. Pat. No. 4,184,498, U.S. Pat. No. 4,195,634, U.S. Pat. No. 4,408,357, and U.S. Pat. No. 4,886,513, which are incorporated herein by reference.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

What is claimed is:

1. A method of making a dissolvable melt-extruded nonwoven fabric, comprising the steps of:
a. providing a polyvinyl alcohol resin;
b. extruding said polyvinyl alcohol resin into filaments;
c. collecting and consolidating said filaments into a nonwoven fabric; and
d. said nonwoven fabric exhibiting the ability to completely dissolve in water temperatures up to about 72° Fahrenheit.

2. A method of making a dissolvable melt-extruded nonwoven fabric as in claim 1, wherein said polyvinyl alcohol resin is at least about 20% hydrolyzed.

3. A method of making a dissolvable melt-extruded nonwoven fabric as in claim 1, wherein said fabric is completely dissolvable in water with temperatures up to about 72° Fahrenheit.

4. A method of making a dissolvable melt-extruded nonwoven fabric as in claim 1, wherein said nonwoven fabric is a melt-blown nonwoven fabric.

5. A method of making a dissolvable melt-extruded nonwoven fabric as in claim 4, wherein said discontinuous filaments have a denier of at least about 3 dpf.

6. A method of making a dissolvable melt-extruded nonwoven fabric as in claim 4, wherein the melt-blown nonwoven fabric has a basis weight range from about 0.75 osy to 8.15 osy.

7. A method of making a dissolvable melt-extruded nonwoven fabric as in claim 1, wherein said dissolvable nonwoven fabric is a medical gown.

8. A method of making a dissolvable melt-extruded nonwoven fabric as in claim 1, wherein said dissolvable nonwoven fabric is an absorbent article component.

9. A method of making a dissolvable melt-extruded nonwoven fabric as in claim 1, wherein said dissolvable nonwoven fabric is a layer of multi-layered construct.

10. A multi-layered construct wherein said construct comprises one or more layers of a dissolvable PVOH melt-blown fabric wherein said dissolvable PVOH melt-blown fabric is comprised of the steps of:
a. providing a polyvinyl alcohol resin;
b. providing a substrate;
c. extruding said polyvinyl alcohol resin into discontinuous filaments;
d. collecting and consolidating said discontinuous filaments onto said substrate; and
e. said consolidated discontinuous filaments exhibiting the ability to completely dissolve in water temperatures up to about 72° Fahrenheit.
